(19) United States
(12) Patent Application Publication
(10) Pub. No.: US 2007/0149229 A1
(43) Pub. Date: Jun. 28, 2007

(54) Apparatus, method and computer program product providing optimized coding performance with power sequences

(75) Inventors: Frank Frederiksen, Klarup (DK); Troels Kolding, Klarup (DK); Preben Mogensen, Gistrup (DK)

Correspondence Address: HARRINGTON & SMITH, PC, 4 RESEARCH DRIVE, SHELTON, CT, 06484-6212, US

(73) Assignee: Nokia Corporation

(21) Appl. No.: 11/645,474

(22) Filed: Dec. 26, 2006

Related U.S. Application Data
(60) Provisional application No. 60/754,439, filed on Dec. 27, 2005.

(51) Int. Cl. H04Q 7/20; H04B 7/00

(52) U.S. Cl. 455/512

(57) ABSTRACT

A method, computer program product and electronic device are provided. The method includes the steps of: prioritizing data for each link into higher priority data and lower priority data for that link; and selectively transmitting a first signal on a first sub-band and a second signal on a second sub-band. The first sub-band is characterized as having better signal transmission characteristics than the second sub-band. The first signal comprises data from the higher priority data and the second signal comprises data from the lower priority data.

### CROSS-REFERENCE TO RELATED APPLICATIONS

This patent application claims priority under 35 U.S.C. §119(e) from Provisional Patent Application No.: 60/754,439, filed Dec. 27, 2005, the disclosure of which is incorporated by reference herein in its entirety.

### TECHNICAL FIELD

The exemplary and non-limiting embodiments of this invention relate generally to wireless communications systems and, more specifically, relate to the transmission of an information stream to a receiver.

### BACKGROUND

The following abbreviations are herewith defined:

3GPP Third Generation Partnership Project

BS base station (also referred to as a Node B)

E-UTRAN Evolved Universal Terrestrial Radio Access Network

H-ARQ hybrid automatic request/acknowledge

HSDPA High Speed Downlink Packet Access

OFDM Orthogonal Frequency Division Multiplex

RF radio frequency

RRM radio resource management

SINR signal to interference plus noise ratio

UE user equipment

UTRAN Universal Terrestrial Radio Access Network

The so-called evolved UTRAN (E-UTRAN) is currently a work item within the 3GPP. For the E-UTRAN system, OFDM has been selected as the multiple access scheme for the downlink (i.e., in the direction from the BS to the UE).

In order to obtain maximum flexibility and also increase the potential peak data rate, one approach is to allocate the full system bandwidth at all cells in the system (thus setting the frequency reuse factor to 1/1). However, this approach creates the potential for a problem to occur at cell edges, where the interference from other cells may be so strong that reception is not possible.

Reference may be had to 3GPP, “Physical Layer Aspects for Evolved UTRAN”, TR 25.814, v 1.0.1 (2005-11), which is incorporated by reference herein in its entirety. For example, section 7.1.2.6.3 is directed to inter-cell interference coordination/avoidance.

### SUMMARY

In an exemplary aspect of the invention, a method is provided. The method includes the steps of: prioritizing data for each link into higher priority data and lower priority data for that link; and selectively transmitting a first signal on a first sub-band and a second signal on a second sub-band. The first sub-band is characterized as having better signal transmission characteristics than the second sub-band. The first signal comprises data from the higher priority data and the second signal comprises data from the lower priority data.

In another exemplary aspect of the invention, a computer program product is provided. The computer program product includes program instructions embodied on a tangible computer-readable medium. Execution of the program instructions results in operations including: prioritizing data for each link into higher priority data and lower priority data for that link; and selectively transmitting a first signal on a first sub-band and a second signal on a second sub-band. The first sub-band is characterized as having better signal transmission characteristics than the second sub-band. The first signal comprises data from the higher priority data and the second signal comprises data from the lower priority data.

In a further exemplary aspect of the invention, an electronic device is provided. The electronic device includes control circuitry and at least one transmitter coupled to the control circuitry. The control circuitry is configured to prioritize data for each link into higher priority data and lower priority data for that link. The at least one transmitter is configured to selectively transmit a first signal on a first sub-band and a second signal on a second sub-band. The first sub-band is characterized as having better signal transmission characteristics than the second sub-band. The first signal comprises the higher priority data and the second signal comprises the lower priority data.

### BRIEF DESCRIPTION OF THE DRAWINGS

The foregoing and other aspects of embodiments of this invention are made more evident in the following Detailed Description, when read in conjunction with the attached Drawing Figures, wherein:

FIG. 1 shows a simplified block diagram of various electronic devices that are suitable for use in practicing the exemplary embodiments of this invention;

FIG. 2 is a conceptual block diagram that illustrates a portion of the Node B of FIG. 1 that includes functionality to implement the exemplary embodiments of this invention; and

FIG. 3 depicts a flowchart illustrating one non-limiting example of a method for practicing the exemplary embodiments of this invention.

### DETAILED DESCRIPTION

One possible approach to circumvent the interference problem discussed above is to use a method that can be referred to as power sequencing in the time or frequency domain. From a network planning/coordination point of view, the power sequence method in the frequency domain is the most attractive. The power sequences would typically be employed such that the total system bandwidth is divided into three equal-size sub-bands which have different power levels allocated for different cells/sectors. Simulations have shown that good performance is obtained where one sub-band is transmitted at a certain power level, while the other two sub-bands are transmitted at power levels that are approximately 4 dB lower than the power level of the strongest sub-band. In some exemplary embodiments, the sub-bands comprise continuous blocks of data. In other exemplary embodiments, the sub-bands do not comprise continuous blocks of data. As a non-limiting example, the sub-bands may comprise alternating sub-bands on a per-physical resource block level.

It is noted that the foregoing is but one example of a power sequence method. Generally, the exemplary embodiments of this invention are applicable to any system using multiple transmit power levels for communication towards a receiver, where the transmitter may utilize the fact that the receiver has knowledge of the relative performance (e.g., transmit power levels) of the sub-bands. The transmitter can utilize this knowledge in order to do the bitmapping.

Consider now a case where the power sequencing method is applied, and also where a user is to be scheduled over the full system bandwidth, or where a user may be scheduled resources simultaneously in a high power and a low power part of the spectrum, while perhaps not over the full system bandwidth. It can be shown that this scenario will cause some bits/symbols to be transmitted (and thus also received) with a higher power than others, thereby resulting in a higher average received SINR value for these transmitted bits/symbols. A turbo coder/decoder that has been chosen for E-UTRAN would ‘prefer’ that all bits are received at the same SINR level. If this is not possible, then an acceptable alternative is to provide a good received SINR for the systematic bits rather than the parity bits. This principle also applies to other methods for forward error correction codes (where some parts of an encoded data stream will almost always be more important than other parts).

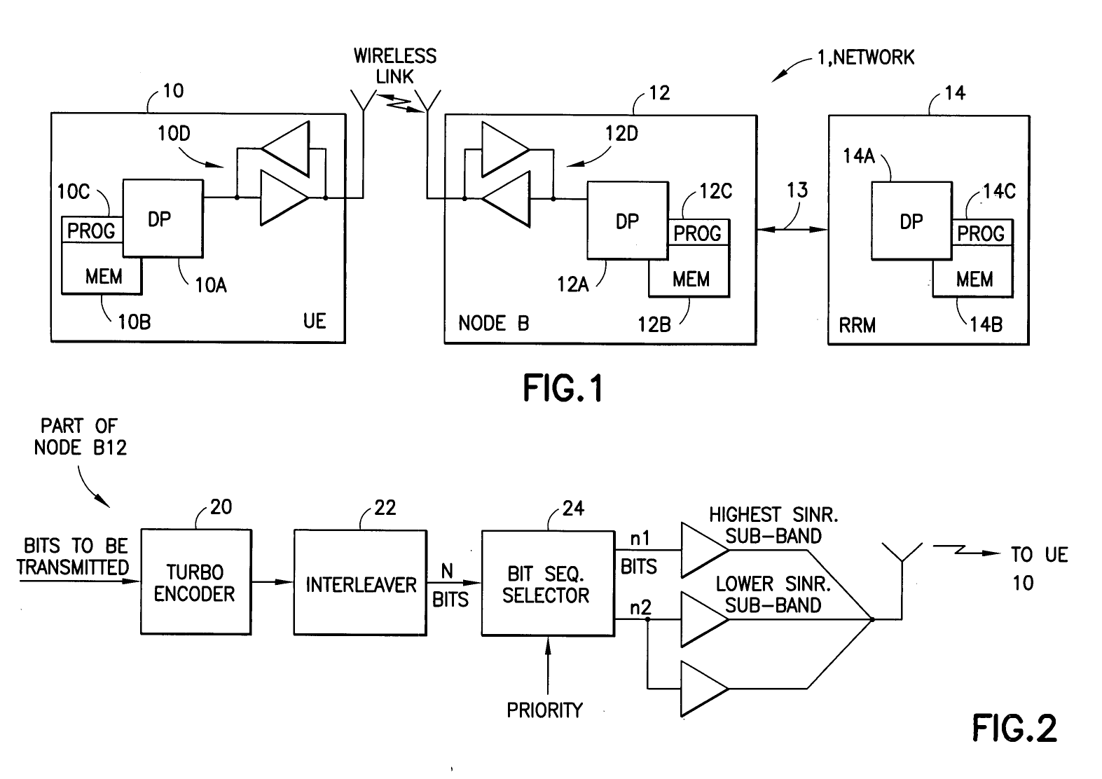

Reference is made first to FIG. 1 for illustrating a simplified block diagram of various electronic devices that are suitable for use in practicing the exemplary embodiments of this invention. In FIG. 1 a wireless network 1 is adapted for communication with a UE 10 via a Node B (base station) 12. The network 1 may include a RRM 14, which may be referred to as a serving RRM (SRRM), or another entity that handles control setup and other functions. The UE 10 includes a data processor (DP) 10A, a memory (MEM) 10B that stores a program (PROG) 10C, and a suitable radio frequency (RF) transceiver 10D for bidirectional wireless communications with the Node B 12, which also includes a DP 12A, a MEM 12B that stores a PROG 12C, and a suitable RF transceiver 12D. The Node B 12 is coupled via a data path 13 to the RRM 14 that also includes a DP 14A and a MEM 14B storing an associated PROG 14C. At least one of the PROGs 10C, 12C and 14C is assumed to include program instructions that, when executed by the associated DP, enable the electronic device to operate in accordance with the exemplary embodiments of this invention, as will be discussed below in greater detail.

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The embodiments of this invention may be implemented by computer software executable by the DP 12A of the Node B 12, the DP 10A of the UE 10 and the other DPs, or by hardware, or by a combination of software and hardware.

The MEMs 10B, 12B and 14B may be of any type suitable to the local technical environment and may be implemented using any suitable data storage technology, such as semiconductor-based memory devices, magnetic memory devices and systems, optical memory devices and systems, fixed memory and removable memory. The DPs 10A, 12A and 14A may be of any type suitable to the local technical environment, and may include one or more of general purpose computers, special purpose computers, microprocessors, digital signal processors (DSPs) and processors based on a multi-core processor architecture, as non-limiting examples.

In accordance with the exemplary embodiments of this invention, the use of power sequences is combined with a forward error correction mechanism where the most important bits (such as the systematic bits for a turbo encoder) are allocated to the carriers (or sub-band) with the highest transmit SINR level.

Note that it is assumed that knowledge is had of interference control (IC) sequences, and thus this knowledge can be used for deriving optimum interleaving patterns. However, since a channel quality indication (CQI) may be reported per sub-band, the invention may use any knowledge of the channel (time or frequency) to optimize the transmission.

The remapping of the important bits is defined in such a way that it provides a simple way of re-arranging the bits before the transmission (and subsequently, also after reception). This may be implemented in a manner similar to that done in H-ARQ bit collection for HSDPA. Reference in this regard may be made to 3GPP TS 25.212, Universal Mobile Telecommunications System (UMTS); Multiplexing and channel coding (FDD); version 6.6.0 Release 6, in particular section 4.2.7.4, Bit separation and collection in downlink, and more specifically section 4.2.7.4.2, Bit collection.

As one non-limiting example of how the exemplary embodiments of the invention may be implemented, and referring also to FIG. 2, assume a total of N bits to be transmitted, where n1 bits are transmitted with high power, and n2 bits are transmitted with lower power, such that N=n1+n2. Then, from a coded and interleaved bit sequence provided by an encoder (e.g., a turbo encoder 20) and an interleaver 22, bit sequence selector logic 24 extracts the first n1 bits and place these in a remapped bit sequence such that they are transmitted in a sub-band using the highest SINR. The remainder of the coded and interleaved sequence is then transmitted on the lower SINR carriers without altering their sequence. The bit sequence selector logic 24 may receive as an input a priority signal from the DP 12A, under control of the PROG 12C, for indicating relative priorities of different bits in the bit stream, enabling the priorities to be changed during operation.

Although shown in FIG. 2 with three sub-bands, any number of sub-bands may be utilized, such as two sub-bands or four sub-bands, as non-limiting examples. Furthermore, although the bit sequence selector logic 24 of FIG. 2 separates the N bits into two groups of bits (n1 bits and n2 bits), in other embodiments the selection logic may separate the bits into any number of groups for transmission on any number of sub-bands, provided the number of groups comprises at least two groups and the number of sub-bands comprises at least two sub-bands.

It is assumed that the UE 10 knows the specifics of the bit prioritization mapping such as by through initial mapping (e.g., by assigning a cell specific power sequence pattern), or by explicit signaling from the Node B 12 whenever the UE 10 is allocated resources, and can thus reconstruct the correct sequence of bits. Thus, it is not necessary to rely on actual transmissions, but one may rely instead on predefined power sequences.

One significant advantage that is realized by the use of the exemplary embodiments of this invention is that the overall performance of the system is improved, due at least in part to the improved performance of the forward error correction.

It should be noted that the exemplary embodiments of this invention may be applied as well in retransmission. For example, if one assumes that the systematic bits are correct, it may be desirable to reverse the approach for the Incremental Redundancy (IR)/Chase Combining (CC) approach. In general, one may desire to selectively prioritize the systematic and the redundancy bits.

In a further non-limiting aspect of the invention, the bit prioritization mapping is applied in the setting of a multi-antenna transmission. So called multiple-input multiple-output (MIMO) methods increase the data rate by adding the possibility to transmit multiple signal streams simultaneously to a user. Thus the bit prioritization mapping can be extended to operate, in addition to the modulation and coding domain, in the domain of the number of streams which all characterize a MIMO transmission method. In this aspect of the invention, there may be a predefined connection between a MIMO transmission method applied on a low-power resource, and a MIMO transmission method applied on a high-power resource. Thus only one of these needs to be signaled. Note that the predefined connection may be limited to the part of the definition of a MIMO transmission scheme that relates to the data rate (i.e. code rate, modulation order, number of streams). In addition to these, data related to the channel realizations on the individual resource units, such as beam information, may or may not be used to determine a MIMO transmission.

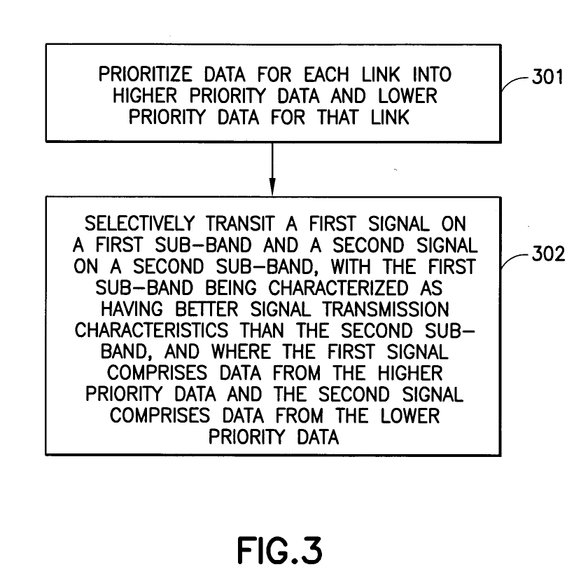

FIG. 3 depicts a flowchart illustrating one non-limiting example of a method for practicing the exemplary embodiments of this invention. The method includes the following steps. In box 301, data is prioritized for each link into higher priority data and lower priority data for that link. In box 302, first and second signals are selectively transmitted on a first sub-band and a second sub-band, respectively, with the first sub-band being characterized as having better signal transmission characteristics than the second sub-band, and where the first signal comprises data from the higher priority data and the second signal comprises data from the lower priority data.

As noted above, the data is prioritized for each link into higher priority data and lower priority data for that link. That is, the data being sent on each link is prioritized per link (e.g., data for link 1 is prioritized into higher priority data and lower priority data) as opposed to prioritizing data among a plurality of links (e.g., the data for link 2 is of a higher priority than the data for link 3).

In other embodiments, the better signal transmission characteristics comprise a better signal to interference plus noise ratio (SINR). In further embodiments, the method further comprises utilizing power sequencing to specify the first sub-band and the second sub-band. In other embodiments, the power sequencing is utilized in a time domain. In further embodiments, the power sequencing is utilized in a frequency domain. In other embodiments, a total system bandwidth is divided into three partitions which have different power levels allocated for different sectors. In further embodiments, the three partitions each have the same size. In other embodiments, the higher priority data comprises turbo encoded systematic bits. In further embodiments, the lower priority data comprises parity bits. In other embodiments, the lower priority data comprises redundancy bits. In further embodiments, the method is applied to a retransmission. In other embodiments, the method is applied to a multiple-input multiple-output (MIMO) transmission. In further embodiments, the method is utilized in conjunction with operation of an Evolved Universal Terrestrial Radio Access Network (E-UTRAN) system.

In other embodiments, the method may further comprise additional steps of prioritizing the data into a lowest priority group and selectively transmitting a signal comprising the lowest priority group on a third sub-band, where the second sub-band is characterized as having better signal transmission characteristics than the third sub-band. In further embodiments, the method may further comprise prioritizing the lower priority data into middle priority data and lowest priority data and selectively transmitting the second signal and a third signal on the second sub-band and a third sub-band, respectively, with the second sub-band being characterized as having better signal transmission characteristics than the third sub-band, and where the second signal comprises data from the middle priority data and the third signal comprises data from the lowest priority data.

The method may further comprise any other aspects of the exemplary embodiments of the invention, or any combination thereof, as discussed herein.

The method may be implemented as a computer program product comprising program instructions embodied on a tangible computer-readable medium, execution of the program instructions resulting in operations comprising the steps discussed above with respect to the method. Such a computer program product may further comprise other aspects of the method and/or other exemplary embodiments of the invention as discussed herein.

Although described herein with respect to division of the bandwidth into two or three different sections (e.g., sub-bands), the exemplary embodiments of the invention may operate to divide the given resource into any suitable number of portions. Furthermore, the size of each portion of the plurality of portions may vary from one to another. That is, the portion size may vary based on factors including relative data importance, as a non-limiting example. As an additional non-limiting example, the portion size may vary according to a pattern known by the transmitter and receiver. As a further non-limiting example, the portion size may be arbitrary. As another non-limiting example, the division into portions can be dynamic, for example, varying every subframe provided that the base station and user equipment both know the pattern of variation.

In one non-limiting, exemplary embodiment, systematic bits are mapped to the best areas before considering lower priority data. Thus, the lower priority data ends up being mapped to lower quality areas.

Furthermore, although described above, in places, as transmitting the higher priority data on the first sub-band and transmitting the lower priority data on the second sub-band, in other exemplary embodiments the entirety of the higher priority data is not transmitted at once on the first sub-band. That is, the signal transmitted on the first sub-band comprises data (e.g., the entirety of or a portion) from the higher priority data. Similarly, the signal transmitted on the second sub-band comprises data (e.g., the entirety of or a portion) from the lower priority data.

Based on the foregoing it should be apparent that the exemplary embodiments of this invention provide a method, apparatus and computer program product(s) to selectively transmit signals as a function of the SINR of various sub-bands, where bits to be transmitted are prioritized such that those bits deemed more important for whatever reason are transmitted on a highest SINR sub-band, and the lower priority bits are transmitted on lower SINR sub-band(s). In a non-limiting example, the higher priority bits may be turbo encoder systematic bits, and the lower priority bits may be redundancy bits.

Although the exemplary embodiments have primarily been described with respect to SINR, the exemplary embodiments may utilize any suitable measure, calculation or determination of the quality of a sub-band to transmit an information-carrying signal. For example, instead of SINR, the exemplary embodiments may employ other measures of signal quality such as bit error rate (BER) or frame error rate (FER), as non-limiting examples.

While the exemplary embodiments have been described above in the context of an E-UTRAN system, it should be appreciated that the exemplary embodiments of this invention are not limited for use with only this one particular type of wireless communication system, and that they may be used to advantage in other wireless communication systems.

In general, the various embodiments maybe implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein maybe implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

Various modifications and adaptations may become apparent to those skilled in the relevant arts in view of the foregoing description, when read in conjunction with the accompanying drawings. For example, while the exemplary embodiments of the invention have been described above in the context of the UTRAN and E-UTRAN systems, it should be appreciated that the exemplary embodiments of this invention can be applied as well to other types of wireless communications systems, methods and schemes. Further by example, in other embodiments more or less than three sub-bands may be employed, as may different types of encoders (e.g., other than turbo encoders). However, any and all modifications of the teachings of this invention will still fall within the scope of the non-limiting embodiments of this invention.

Furthermore, some of the features of the various non-limiting embodiments of this invention may be used to advantage without the corresponding use of other features. As such, the foregoing description should be considered as merely illustrative of the principles, teachings and exemplary embodiments of this invention, and not in limitation thereof.

What is claimed is:

1. A method comprising:
prioritizing data for each link into higher priority data and lower priority data for that link;
selectively transmitting a first signal on a first sub-band and a second signal on a second sub-band, wherein the first sub-band is characterized as having better signal transmission characteristics than the second sub-band, wherein the first signal comprises data from the higher priority data and the second signal comprises data from the lower priority data.

2. The method of claim 1, wherein the better signal transmission characteristics comprise a better signal to interference plus noise ratio (SINR).

3. The method of claim 1, further comprising:
utilizing power sequencing to specify the first sub-band and the second sub-band.

4. The method of claim 3, wherein power sequencing is utilized in a time domain.

5. The method of claim 3, wherein power sequencing is utilized in a frequency domain.

6. The method of claim 1, wherein a total system bandwidth is divided into a plurality of partitions which have different power levels allocated for different sectors.

7. The method of claim 6, wherein each partition of the plurality of partitions has a size known by a transmitter performing the selective transmission of signals on the first sub-band and the second sub-band and by a receiver that receives the selectively transmitted signals.

8. The method of claim 1, wherein the higher priority data comprises turbo encoded systematic bits.

9. The method of claim 1, wherein the lower priority data comprises parity bits.

10. The method of claim 1, wherein the lower priority data comprises redundancy bits.

11. The method of claim 1, wherein the method is applied to a retransmission.

12. The method of claim 1, wherein the method is applied to a multiple-input multiple-output (MIMO) transmission.

13. The method of claim 1, wherein the method is utilized in conjunction with operation of an Evolved Universal Terrestrial Radio Access Network (E-UTRAN) system.

14. A computer program product comprising program instructions embodied on a tangible computer-readable medium, execution of the program instructions resulting in operations comprising:
prioritizing data for each link into higher priority data and lower priority data for that link;
selectively transmitting a first signal on a first sub-band and a second signal on a second sub-band, wherein the first sub-band is characterized as having better signal transmission characteristics than the second sub-band, wherein the first signal comprises data from the higher priority data and the second signal comprises data from the lower priority data.

15. The computer program product of claim 14, wherein the better signal transmission characteristics comprise a better signal to interference plus noise ratio (SINR).

16. The computer program product of claim 14, wherein execution of the program instructions results in operations further comprising:
utilizing power sequencing to specify the first sub-band and the second sub-band.

17. The computer program product of claim 16, wherein power sequencing is utilized in a time domain.

18. The computer program product of claim 16, wherein power sequencing is utilized in a frequency domain.

19. The computer program product of claim 16, wherein the higher priority data comprises turbo encoded systematic bits.

20. The computer program product of claim 16, wherein the lower priority data comprises parity bits.

21. The computer program product of claim 16, wherein the lower priority data comprises redundancy bits.

22. The computer program product of claim 16, wherein the computer program product is applied to a retransmission.

23. The computer program product of claim 16, wherein the computer program product is applied to a multiple-input multiple-output (MIMO) transmission.

24. The computer program product of claim 16, wherein the computer program product is utilized in conjunction with operation of an Evolved Universal Terrestrial Radio Access Network (E-UTRAN) system.

25. An electronic device comprising:
control circuitry configured to prioritize data for each link into higher priority data and lower priority data for that link; and
at least one transmitter coupled to the control circuitry, wherein the at least one transmitter is configured to selectively transmit a first signal on a first sub-band and a second signal on a second sub-band, wherein the first sub-band is characterized as having better signal transmission characteristics than the second sub-band, wherein the first signal comprises data from the higher priority data and the second signal comprises data from the lower priority data.

26. The electronic device of claim 25, wherein the control circuitry comprises at least one data processor coupled to at least one memory.

27. The electronic device of claim 25, wherein the control circuitry comprises a turbo encoder.

28. The electronic device of claim 27, wherein the higher priority data comprises turbo encoded systematic bits.

29. The electronic device of claim 27, wherein the lower priority data comprises parity bits.

30. The electronic device of claim 25, wherein the control circuitry comprises bit sequence selector logic.

31. The electronic device of claim 30, wherein the bit sequence selector logic is configured to receive a priority signal, wherein the priority signal indicates relative priorities of different portions of the data.

32. The electronic device of claim 31, wherein the bit sequence selector logic enables the prioritization of the data to be changed during operation.

33. The electronic device of claim 25, wherein the lower priority data comprises redundancy bits.

34. The electronic device of claim 25, further comprising a plurality of antennas coupled to the transmitter, wherein the transmitter is configured to transmit a multiple-input multiple-output (MIMO) transmission.

35. The electronic device of claim 25, wherein the electronic device operates as a component in an Evolved Universal Terrestrial Radio Access Network (E-UTRAN) system.
